(19) United States
(12) Patent Application Publication
(10) Pub. No.: US 2005/0017620 A1
(43) Pub. Date: Jan. 27, 2005

(54) Display panel module

(76) Inventors: Kyung Ku Kim, Seoul (KR); Hong-Rae Cha, Seoul (KR); Myeong Soo Chang, Woowang-si (KR)

Correspondence Address: FLESHNER & KIM, LLP, P.O. BOX 221200, CHANTILLY, VA, 20153, US

(21) Appl. No.: 10/895,987

(22) Filed: Jul. 22, 2004

(30) Foreign Application Priority Data
Jul. 22, 2003 (KR) 10-2003-0050165

(51) Int. Cl. H01K 1/26; H01K 1/30

(52) U.S. Cl. 313/112

(57) ABSTRACT

Disclosed is a display panel module including: a display panel; a film type front filter formed on the display panel for being combined with the display panel; and a ground electrode coupled to an EMI shielding film of the film type front filter and upwardly bent to encompass at least one side of the film type front filter, and thereby preventing the emission of electromagnetic waves to outside.

### BACKGROUND OF THE INVENTION

1. Field of the Invention

The present invention relates in general to a display panel module, more particularly, to a display panel module having a front filter capable of shielding EMI.

2. Discussion of the Background Art

In general, PDPs display an image by controlling gas discharge time of each pixel on the basis of digital video data. Typical examples of these PDPs are AC FDPs, as shown in FIG. 1. The AC PDP includes three electrodes and is driven by an AC voltage.

FIG. 1 is a perspective view of a related art AC PDP 30. More particularly, FIG. 1 illustrates the structure of a discharge cell corresponding to a sub-pixel.

As shown in FIG. 1, the discharge cell is divided into an upper plate 15 and a lower plate 25. The upper plate 15 includes an upper substrate 10 where a sustain electrode pair 12A and 12B, an upper dielectric layer 14, and a protective film 16 are formed in sequence. The lower plate 25 includes a lower substrate 18 where a data electrode 20, a lower dielectric layer 22, a barrier rib 24, and fluorescent layers 26 are formed in sequence.

The upper substrate 10 and the lower substrate 18 are spaced out in parallel by the barrier rib 24.

The sustain electrode pair 12A and 12B respectively includes a transparent electrode for transmitting visible rays, and a metal electrode for compensating resistance of the transparent electrode. The transparent electrode is relatively wider than the metal electrode.

The sustain electrode pair 12A and 12B includes a scan electrode 12A and a sustain electrode 12B. The scan electrode 12A provides scan signals for determining data supply time and sustain signals for sustaining the gas discharge. On the other hand, the sustain electrode 12B mainly provides sustain signals for sustaining the discharge.

The upper dielectric layer 14 and the lower dielectric layer 22 are piled up with charges from the gas discharge.

The protective film 16 protects the upper dielectric layer 14 from damages caused by a sputtering of plasma and thus, extends lifespan of the PDP and improves the emission efficiency of secondary electrons. The protective film 16 is usually made from magnesium oxide (MgO).

The dielectric layers 14 and 22 and the protective film 16 lower an externally applied discharge voltage. The data electrode 20 is formed at right angles to the sustain electrode pair 12A and 12B. The data electrode 20 provides data signals for selecting cells to be displayed.

The barrier rib 24 and the upper and lower substrates 10 and 18 create a discharge space. Also, the barrier rib 24 is formed in parallel with the data electrode 20, and prevents ultraviolet rays generated by the gas discharge from leaking to the adjacent discharge cells.

The fluorescent layer 26 is applied to the surface of the lower dielectric layer 22 and barrier rib 24, and generates one of visible rays in red, blue, or blue.

The discharge space is filled with inert gases including He, Ne, Ax, Xe, and Kr, or different compositions of the inert gas mixtures, or Excimer gas for generating ultraviolet rays by the gas discharge.

Thusly structured discharge cell is selected by an opposing electrode discharge between the data electrode 20 and the scan electrode 12A, and is sustained by a surface discharge between the scan electrode 12A and the sustain electrode 12B. Therefore, the fluorescent layer 26 is excited by ultraviolet rays generated during the sustain discharge, and visible rays are emitted to the outside of the cell. In this case, the discharge cell controls the cell's discharge sustain period, namely frequency of the sustain discharge, according to video data, and exits a light at a gray scale level.

FIG. 2 is a schematic perspective view of a PDP set including the PDP 30 of FIG. 1, and FIG. 3 is a cross-sectional view illustrating one side of the PDP set of FIG. 2.

As shown in FIG. 2 and FIG. 3, the PDP set includes a case 60, a printed circuit board 50 (hereinafter, it is referred to as “TCB”) housed in the case 60, a PDP 30, a glass type front filter 40, and a cover 70 connected to the case 60 and encompassing the glass type front filter 40.

As discussed before with reference to FIG. 1, the PDP 30 includes an upper plate 15 and a lower plate 25 being connected to each other.

The PCB 50 disposed on the rear surface of the PDP 30 includes a plurality of driving and control circuits for driving the sustain electrode pair 12A and 12B and the data electrode 20 formed on the PDP 30. Between the PCB 50 and the PDP 30 is a heat radiation plate 80 for radiating heat emitted from the PDP 30 and the PCB 50.

The glass type front filter 40 shields electromagnetic waves generated from the PDP 30 towards the front surface, prevents external light reflection, blocks near-infrared rays, and corrects colors. To this end, the glass type front filter 40 includes, as shown in FIG. 4, a first antireflection coating 44 attached to a front surface of a glass substrate 42, and EMI shielding film 46, a NIR (near infrared ray) blocking film 48, a color correcting film 52, and a second antireflection coating 54, where the EMI shielding film 46, the NIR blocking film 48, the color correcting film 52 and the second and antireflection coating 54 are layered in cited order on the rear surface of the glass substrate 42.

The glass substrate 42 is made from a reinforced glass to support the glass type front filter 40 and to protect the front filter 42 and the PDP 30 from damages caused by external impacts. The first and second antireflection coatings 44 and 54 prevent incident light rays from outside from reflecting back to the outside and thus, improve contrast effects.

The EMI shielding film 46 absorbs electromagnetic waves generated from the PDP 30, and shields the emission of the electromagnetic waves to outside. The NIR blocking film 48 absorbs near infrared rays at a wavelength band of 800-1000 nm that are generated from the PDP 30, and blocks the emission of the near infrared rays to outside. This is how infrared rays (approximately 947 nm) generated from a remote controller are normally input to an infrared ray receiver built in the PDP set. The color correcting film 52 contains a color dye to adjust or correct colors, and consequently improves color purity. These films 44, 46, 48, 52, and 54 are adhered to the glass substrate 42 through an adhesive or glue.

Referring to FIG. 5, the glass tape front filter 40 is electrically connected to the case 60 through a gasket 78 that is coupled to a filter supporter 82. More specifically, the filter supporter 82 is connected to part of the rear surface of the front filter 40. At this time, the filter supporter 82 is electrically connected to be EMI shielding film 46 of the glass type front filter 40 spaced apart from the PDP 30. That is, the filter supporter 82 connects the front filter 40 to the case 60 to shield EMI and/or near infrared rays.

The case 60 protects the PCB 50, the glass type front filter 40 and the PDP 30 from external shocks, and shields electromagnetic waves emitted from side and rear surfaces of the PDP 30. Also, to ensure that the glass type front filter 40 is separated from the PDP 30, the case 60 is electrically connected to the EMI shielding film 46 of the glass type front filter 40 through the filter supporter 82 that supports the rear surface of the case 60. Therefore, the case 60 and the EMI shielding film 46 of the glass type front filter are both earthed to a ground voltage and absorb electromagnetic waves emitted from the PDP 30 and discharge them.

Lastly, the cover 70 encompasses the outside of the glass type front filter 40 and is combined with the case 60.

As discussed above, the related art PDP set includes the glass type front filter 40 for shielding electromagnetic waves and correcting optical characteristics. However, because the glass type front filter 40 includes a glass substrate made from the reinforced glass, which is relatively thick, the thickness and weight of the PDP set were increased, and the cost of manufacture was also increased.

As an attempt to solve the above-described problems, a film type front filter without a glass substrate, as shown in FIG. 6, has been suggested. The film type front filter 90 shown in FIG. 6 includes a color correcting film 98, a NIR blocking film 96, and EMI shielding film 94, and an antireflection coating 92, each being sequentially adhered to an upper plate 15 of the PDP 30.

The antireflection coating 92 prevents incident light rays from outside from reflecting back to the outside. The EMI film 94 absorbs electromagnetic waves generated from the PDP 30 and shields the emission of the electromagnetic waves to outside. The NIR blocking film 96 absorbs near infrared rays that are generated from the PDP 30 and blocks the emission of the near infrared rays to outside. The color correcting film 98 contains a color dye to adjust or correct colors and consequently improves color purity. These films 92, 94, 96, and 98 are adhered to the upper plate 15 of the PDP 30 through an adhesive or glue.

Compared to the glass type front film 40, the film type front filter 90 is light and made thin. Also, it costs much less to manufacture the film type front filter 90. However, as the film type front filter 90 is combined with the PDP 30, the EMI shielding film 94 and the filter supporter located on the rear surface of the film type front filter 90 are not electrically connected to each other. As a result of this, the film type front filter 90 is not capable of shielding the electromagnetic interference.

### SUMMARY OF THE INVENTION

An object of the invention is to solve at least the above problems and/or disadvantages and to provide at least the advantages described hereinafter.

Accordingly, one object of the present invention is to provide a display panel module with a front filter capable of shielding electromagnetic interference (EMI).

The foregoing and other objects and advantages are realized by providing a display panel module including a display panel; a film type front filter formed on the display panel for being combined with the display panel; and a ground electrode coupled to an EMI shielding film of the film type front filter and upwardly bent to encompass as least one side of the film type front filter and thereby preventing the emission of electromagnetic waves to outside.

Another aspect of the present invention provides a display panel module including: a display panel; a film type front filter formed on the display panel; and a conductive tape for electrically earthing the film type front filter.

The display panel module of the present invention uses the conductive tape for earthing the EMI shielding film by adhering the conductive tape from inside to outside the front filter. Therefore, the electromagnetic waves and/or near infrared rays of the PDP with the film type front filter can be more effectively shielded.

Moreover, since the black material included in the EMT shielding film is formed on the side where the user can see, contrast deterioration (tonal fading) can be prevented. Also, since the conductive metal patterning and the black material patterning are carried out at the same time, the black layer forming process can be eliminated and as a result of this, the manufacture process is much simplified and the cost of manufacture is reduced.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a perspective view of a related art three-electrode AC surface discharge plasma display panel (PDP);

FIG. 2 is an exploded perspective view of a PDP set including a PDP of FIG. 1;

FIG. 3 is a cross-sectional view showing the vertical structure of a DPD set of FIG. 2;

FIG. 4 is a cross-sectional view showing the vertical structure of a glass type front filter and PDP of FIG. 2;

FIG. 5 is a cross-sectional view showing in detail the connection relation between a glass type front filter and a filter supporter;

FIG. 6 is a cross-sectional view showing the vertical structure of a PDP to which a related art film type front filter is attached;

FIG. 7 is a cross-sectional view showing the vertical structure of a PDP to which a film type front filter of the present invention is attached; and

FIG. 8 is a cross-sectional view showing in detail the connection relation between a film type front filter of FIG. 7 and a filter supporter.

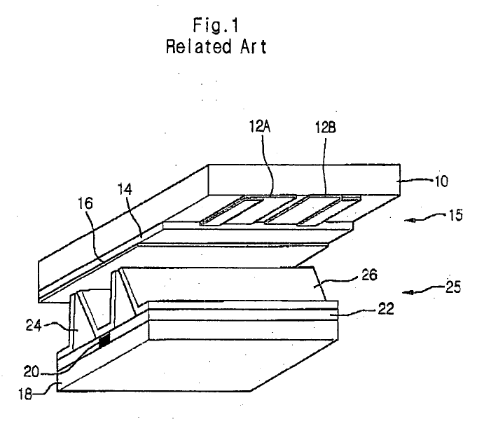

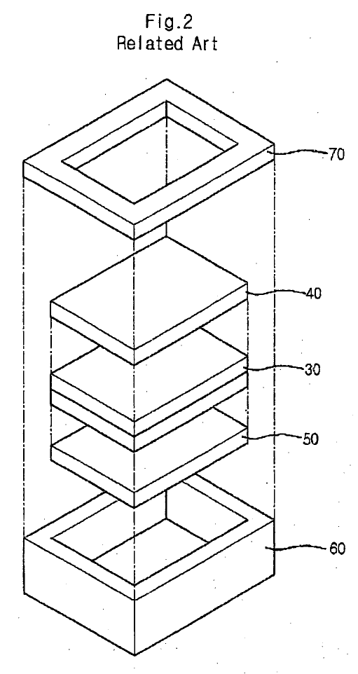

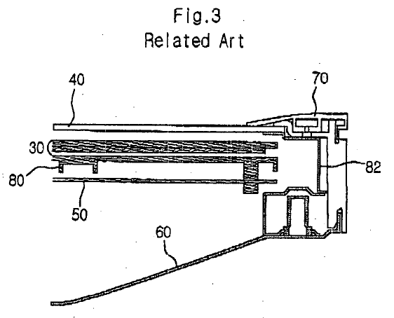

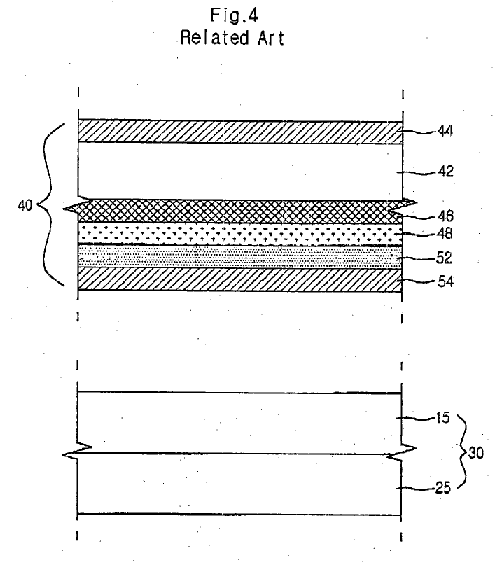

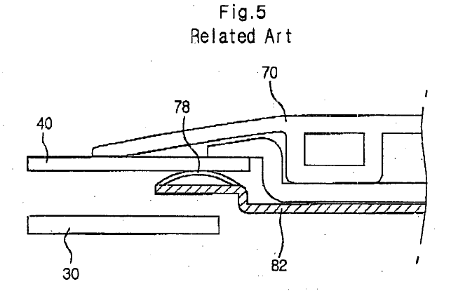

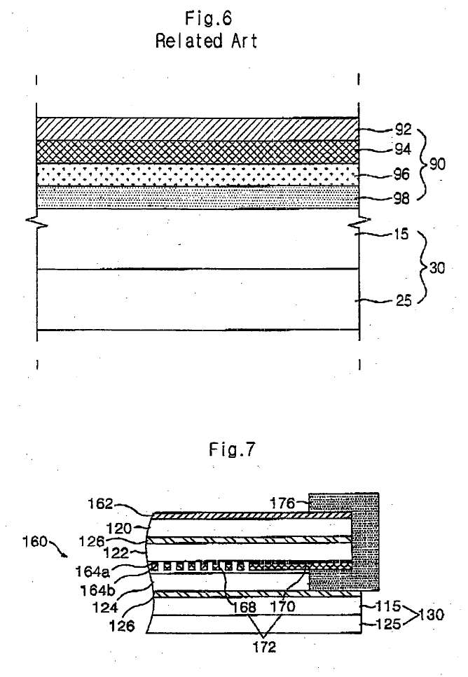

### DETAILED DESCRIPTION OF PREFERRED EMBODIMENTS

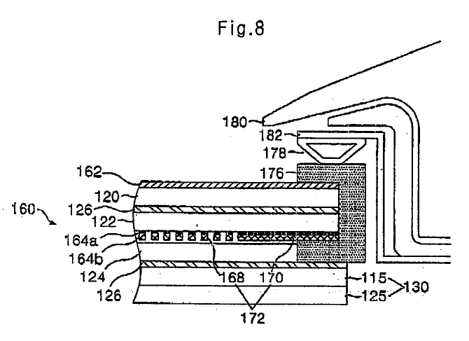

The following detailed description will present a preferred embodiment of the invention in reference to the accompanying drawings FIGS. 7 and 8. FIG. 7 is a cross-sectional view a film type front filter of the present invention.

As shown in FIG. 7, the film type front filter 160 includes an EMI shielding film 172 and an antireflection coating 162, which are formed sequentially on an upper plate 115 of a PDP 130.

The antireflection coating 162 is formed on the front surface of a first base film 120 and prevents incident light rays from outside from reflecting back to the outside.

The EMI shielding film 172 absorbs electromagnetic waves generated from the PDP 130 and shields the emission of the electromagnetic waves to outside. The EMI shielding film 172 is formed on the rear surface of the first base film 120 and its front surface is adhered to the rear surface of a second base film 122 through an adhesive 126. The EMI shielding film 172 includes a conducive mesh 168, and a black frame 170 for supporting the conductive mesh 168.

The conductive mesh 168 is formed on an effective screen area, and to obtain high visible light transmittance from the PDP 130 it creates polygon shaped holes therebetween.

The conductive mesh 168 is formed by patterning black material 164a and a metal layer 164b formed on the black material 164a through a photolithography process.

The metal layer 164b is either a double metal layer composed of a first metal layer made from silver (Ag) or copper (Cu) and a second metal layer made from a transparent conductive material, or a single metal layer composed of the first metal layer only.

If the metal layer is composed of the first and second metal layers, the EMI shielding film 172 alone can absorb near infrared rays generated from the PDP 130 and shield the emission of the near infrared rays to outside. On the other hand, if the EMI shielding film 172 includes the single metal layer, the film type front filter 160 needs a separate NIR blocking film (not shown).

The black frame 170 is foxed outside the effective screen area, that is, on non-effective screen area. The black frame 170 is made from the same material with the conductive mesh 168.

Here, the black material 164a included in the black frame 170 and the conductive mesh 168 is made from at least one pigment or dye selected from a group consisting of titanium oxide (rutile structure, anatase structure), cadmium yellow, lead-tin yellow, molybdate orange, cadmium red, iron oxide, copper phtalocyanine green/blue/ultramarine blue, carbon black, torchsky, phtalocyanine green, cobalt blue, cobalt bio red, mineral bio red, chromium oxide, indanthrene blue, carbon I, carbon II, phtalocyanine blue, aniline black, azo pigment, azo dye, azo compounds, azo basic oxide pigment, metal complex salts, metals, and metal oxides. Also, the black material 164a is made from an aniline-formaldehyde resin, a material from the aryl group, or an arylation product resin. Also, the black material 164a is made from an inorganic material containing metal like Nd₂O₃, Nd group, Fe and iron oxides, Ag and silver oxides, Ni and nickel oxides, and Cr and chromium oxides.

Alternatively, the EMI shielding film 172 can be a single layer as well, which is formed by patterning the metal layer made of Ag, Cu, Au or Al, and blackening the surface of the metal pattern. This type of EMI shielding film 172 formed of the black metal layer not only shields the emission of the electromagnetic waves from the PDP 130 to outside, but also is used as a black frame for defining the effective screen area.

A color correcting film (not shown) contains a dye for color adjustment, so that the colors can be adjusted to increase color purity.

These films (the EMI shielding film 172 and the antireflection coating 162) are formed, more specifically, adhered on the base films 120, 122, and 124 through an adhesive or glue, and are attached to the upper plate 115 of the PDP 130.

The upper and lower plates 115, 125 of the PDP 130 are cohered to each other, creating a gas discharge space therebetween. Using this gas discharge, the PDP displays an image.

A conductive tape 176 of the film type front filter of the invention has a “C” shape or “c” shape so that the conductive tape 176 is connected to the EMI shielding film 172 and at the same time encompasses the side of the film type front filter 160. As shown in FIG. 8, the conductive tape 176 is electrically connected to a covet 180 or a case (not shown) trough a spring gasket 178 coupled to the filter supporter 182, and is used as a ground electrode for earthing the black frame 170 of the EMI shielding film with the case. In other words, the EMI shielding film 172 is electrically connected to the case through the conductive tape 176, and serves to shield electromagnetic waves and/or near infrared rays. As for the conductive tape 176, a silver (Ag) fiber tape, a silver (Ag) paste, a nickel (Ni) fiber tape, a copper (Cu) tape, or a metal alloy, each having a thickness of 10-300 μm, is used

Referring to FIG. 8, the conductive tape 176 is first taped on the black frame 170 of the EMI shielding film 172. Then the conductive tape 176 is bent in such a manner to encompass at least one side of the film type front filter 160 and is taped to the edge of the antireflection coating 162.

After taping the conductive tape 176 on the black frame 170 of the EMI shielding film 172, an adhesive 126 is applied to the rear surface of the conductive tape 176 or on the upper plate 115 of the PDP 130 so that the conductive tape 176 is well adhered to the side of the front filter 160 and the edge of the antireflection coating 162 on the top of the front filter 160. The adhesive applied to the rear surface of the conductive tape 176 or the upper plate 115 of the PDP 130 is used to combine the PDP 130 with the film type front filter 160.

Alternatively, at least part of the conductive tape 176 can be a double sided tape. In this manner, the conductive tape 176 is taped to the black frame 170 of the EMI shielding film and to the upper plate 115 of the PDP 130 as well.

Afterwards, the conductive tape 176 is upwardly bent to encompass the side of the film type front filter 160 and then is taped to the edge of the antireflection coating 162. Therefore, the conductive tape 176 can earth the black frame 170 with the case and through this conductive tape 176 the PDP 130 and the film type front filter 160 are combined together.

As described above, the conductive tape 176 is taped to the upper plate 115 of the PDP 130 through glue or an adhesive 126. Alternatively, the conductive tape 176 can be made relatively thin. In such case, a separate adhesive or glue is used to adhere the conductive tape 176 to the upper plate 115 of the PDP 130.

In conclusion, the display panel module of the present invention uses the conductive tape for earthing the EMI shielding film by adhering the conductive tape from inside to outside the front filter. Therefore, the electromagnetic waves and/or near infrared rays of the PDP with the film type front filter can be more effectively shielded.

Moreover, since the black material included in the EMI shielding film is formed on the side where the user can see, contrast deterioration (tonal fading) can be prevented. In addition, since the conductive metal patterning and the black material patterning are carried out at the same time, the black layer forming process can be eliminated and this consequently simplifies the manufacture process and reduces the cost of manufacture.

While the invention has been shown and described with reference to certain preferred embodiments thereof, it will be understood by those skilled in the art that various changes in form and details may be made therein without departing from the spirit and scope of the invention as defined by the appended claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. A display panel module comprising:
a display panel;
a film type front filter formed on the display panel for being combined with the display panel; and
a ground electrode coupled to an EMI shielding film of the film type front filter and upwardly bent to encompass at least one side of the film type front filter, and thereby preventing the emission of electromagnetic waves to outside.

2. The display panel module according to claim 1, where the film type front filter comprises an antireflection coating for preventing external light reflection, and an EMI shielding film including conductive patterns for preventing the emission of electromagnetic waves from the display panel and a black frame for defining an effective screen area of the display panel.

3. The display panel module according to claim 2, wherein one end of the ground electrode is coupled to the black frame, and the other end of the ground electrode is coupled to the antireflection coating.

4. The display panel module according to claim 1, wherein the ground electrode is formed into a “C” shape.

5. The display panel module according to claim 1, wherein the ground electrode is a conductive tape.

6. The display panel module according to claim 5, wherein the ground electrode comprises at least one of a silver fiber tape, silver paste, nickel fiber tape and copper tape.

7. The display panel module according to claim 5, wherein the ground electrode has a thickness of 10-300 μm.

8. The display panel module according to claim 5 further comprises an adhesive for adhering the ground electrode to an upper plate of the display panel.

9. The display panel module according to claim 1, wherein the ground electrode is a conductive tape having a double sided tape portion.

10. The display panel module according to claim 2 further comprises a filter supporter for electrically connecting the ground electrode disposed on the antireflection coating to a case.

11. The display panel module according to claim 2, wherein the EMI shielding film is comprised of a black material and at least one metal layer formed on the black material.

12. The display panel module according to claim 11, wherein the black material is made from one of the following:
at least one pigment (dye) selected from a group consisting of titanium oxide (rutile structure, anatase structure), cadmium yellow, lead-tin yellow, molybdate orange, cadmium red, iron oxide, copper phtalocyanine green/blue/ultramarine blue, carbon black, torchsky, phtalocyanine green, cobalt blue, cobalt bio red, mineral bio red, chromium oxide, indanthrene blue, carbon I, carbon II, phtalocyanine blue, aniline black, azo pigment, azo dye, azo compounds, azo basic oxide pigment, metal complex salts, metals, and metal oxides;
a resin selected from a group consisting of aniline-formaldehyde resin, aryl group, arylation product; and
an inorganic material-containing metal selected from a group consisting of Nd₂O₃, Nd group, Fe and iron oxides, Ag and silver oxides, Ni and nickel oxides, and Cr and chromium oxides.

13. The display panel module according to claim 2, wherein the EMI shielding film is formed by blackening a metal pattern.

14. The display panel module according to claim 13, wherein the metal pattern comprises one of silver, copper, gold, and aluminum.

15. A display panel module comprising:
a display panel;
a film type front filter formed on the display panel; and
a conductive tape for electrically earthing the film type front filter.

16. The display panel module according to claim 15, wherein the conductive tape is taped to at least one side of the film type front filter.

17. The display panel module according to claim 15, wherein one end of the conductive tape is formed between the display panel and the film type front filter, and the other end of the conductive tape is formed between the film type front filter and a cover.

18. The display panel module according to claim 15, wherein the conductive tape is in contact with an EMI shielding film of the film type front filter.
